(19) United States
(12) Patent Application Publication
(10) Pub. No.: US 2014/0280335 A1
(43) Pub. Date: Sep. 18, 2014

(54) SYSTEM AND METHOD TO ALLOW A DOMAIN NAME SERVER TO PROCESS A NATURAL LANGUAGE QUERY AND DETERMINE CONTEXT

(71) Applicant: QUALCOMM Incorporated, San Diego, CA (US)

(72) Inventors: Eric P. Bilange, San Digo, CA (US); Peter S. Marx, San Diego, CA (US); Ian R. Heidt, Carlsbad, CA (US); Cormac S. Conroy, Palo Alto, CA (US)

(73) Assignee: QUALCOMM Incorporated, San Diego, CA (US)

(21) Appl. No.: 13/797,249

(22) Filed: Mar. 12, 2013

(51) Int. Cl. G06F 17/30

(52) U.S. Cl. CPC G06F 17/30864
USPC 707/771; 707/769

(57) ABSTRACT

A method for processing a natural language query and determining context includes receiving a natural language query from a user device, determining context of the user device, using the determined context to identify a web server having information related to the natural language query, sending information identifying the user device and the natural language query to the web server; and identifying the web server to the user device.

### DESCRIPTION OF THE RELATED ART

Information in the form of content from websites is typically provided to many different types of devices and users. One type of device and user that is increasingly receiving more and more web content is a wireless device and a mobile user. A wireless device can be a portable computing device, a tablet computer, a smart phone, or any other portable, or wireless device that is capable of browsing and receiving web content.

A web browser on a mobile computing device provides the primary way to accesses information online. When a web browser is used to enter a natural language query that does not immediately relate to a domain name or to an IP address, the natural language query is typically sent to a web-based search application, such as Google or Yahoo, to search for a likely domain or IP address that is related to the natural language query. The web search application then performs a web search using the natural language query and then returns a number of possible domain and IP address choices to the web browser. Unfortunately, sending the natural language query to a web search application, such as Google or Yahoo, takes additional time and resources, and does not take into account any device context, such as the location, of the mobile computing device.

Therefore, it would be desirable to allow local searching using a natural language query without employing an external web search application.

### SUMMARY

An embodiment of a method for processing a natural language query and determining context includes receiving a natural language query from a user device, determining context of the user device, using the determined context to identify a web server having information related to the natural language query, sending information identifying the user device and the natural language query to the web server; and identifying the web server to the user device.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram of an embodiment of a system and method to allow a domain name server (DNS) to process a natural language query and determine context.

FIG. 2 is a call flow diagram illustrating an embodiment of a method to allow a domain name server (DNS) to process a natural language query and determine context.

FIGS. 3A and 3B collectively are a flow chart illustrating an embodiment of a method to allow a domain name server (DNS) to process a natural language query and determine context.

FIG. 4 is a block diagram of the query engine of FIG. 1.

FIG. 5 is a block diagram of the table of FIG. 4.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the term “user device” includes a device capable of receiving content from a web site and transmitting information to a website. A user device can be a stationary device, a wireless device or a mobile device.

As used herein, the term “user” refers to an individual receiving content on a user device and transmitting information to a website.

As used herein, the term “context” refers to any or all attributes of the user or the user device, such as physical, logical, social and other contextual information.

As used herein, the terms “context aware metadata” and “contextual metadata” refer to metadata that describes or defines the context of a user or a user device.

As used herein, the term “context aware content” refers to content that is delivered to a user device and that is tailored to a user's context.

As used herein, the term “web property” refers to an entity having one or more websites having one or more web pages.

As used herein, the term “natural language” refers to a search query that can be entered into an electronic device, where the search query does not include sufficient information to allow a domain name server (DNS) to map the search query directly to a domain name and/or an Internet Protocol (IP) address. An example of a natural language search query is one that does not include a domain name or sufficient portions of a domain name to allow a DNS to identify an IP address corresponding to the query.

In an embodiment, a system and method to allow a domain name server (DNS) to process a natural language query and determine context can be implemented as part of a system that allows a wireless device to access the World Wide Web.

FIG. 1 is a functional block diagram of an embodiment of a system and method to allow a domain name server (DNS) to process a natural language query and determine context. The system 100 will be described in the context of a local area network (LAN), such as a wireless network located within a particular location or venue. However, the system 100 is applicable to other types of networks and locations. In an embodiment, the system 100 will be described using a wireless fidelity (WiFi) network implemented at a location or at a venue. Examples of such locations include an airport, a sporting event venue, a shopping mall or shopping district, an entertainment venue, a theme park, or any other location.

The system 100 comprises a user device 102, a network 106, a domain name server (DNS) 108, a web server 110, a web server 120 and a query engine 112. The user device 102 comprises a web browser 104, such as a hypertext transfer protocol (HTTP) web browser 104 for accessing and viewing web content. The web server 110 and the web server 120 can each be an HTTP server. The user device 102 can be a stationary device or a mobile device. In an embodiment, the user device 102 is a mobile device, such as a smart phone that can wirelessly connect to the network 106. In an embodiment, the network 106 can comprise one or more networks and comprises functionality that provides a number of processing and communication functions, including, but not limited to, one or more access points (AP) 105a, 105b and 105c, as examples, and router/switch logic 107. The location of the user device 102 within the system 100 can, at least in part, be determined by a location/position element 116 that is connected to the router/switch logic 107, and by the access point 105 to which the user device 102 is connected. In an embodiment, the user device 102 is connected to the network 106 through the access point 105a over a wireless connection 103. In this example, the wireless connection 103 may be a WiFi connection, or another wireless connection. In an embodiment, the location/position element 116 can determine the particular access point (AP 105a in this example) to which the user device 102 is connected, and can therefore determine the location of the user device 102 at least to within a level of granularity determined by the router/switch logic 107, the network 106, and the location/position element 116, depending on the size of the area covered by the particular access point to which the user device 102 is connected. Moreover, information, such as signal strength, bit error rate (BER), round trip latency between the user device 102 and the network 106, or other parameters, from each access point can be analyzed by the location/position element 116 to further determine the location of the user device 102 within the system 100.

The DNS 108 is coupled to the network 106 over a bi-directional connection 109 and to the location/position element 116 over bi-directional connection 113. The location/position element 116 is also coupled to the router/switch logic 107 over bi-directional connection 121. The bi-directional connections 109, 113 and 121 can comprise one or more direct connections, wireless connections, and/or networks. The DNS 108 and the location/position element 116 can be located within the network 106 or outside of the network 106. The DNS 108 can use the location/position element 116 to determine the location of the user device 102.

The DNS 108 implements a domain name system, which is a standard technology for managing the names of Web sites and other Internet domains. Domain name system technology allows a user to type a domain name into a web browser and a DNS 108 automatically finds an IP address on the Internet that corresponds to the domain name. However, in some instances, the domain name is not known or is not available to the user, or the user wishes to use a natural language search query for other reasons. However, a DNS cannot map a natural language search query to an IP address. In an embodiment, the DNS 108 also comprises a query cache 113. The query cache 113 can contain associations and/or resolutions for every IP address processed by the DNS 108. The query cache 113 allows a web server to have access to an original natural language query sent by the user device 102.

The query engine 112 is connected to the DNS 108 over a bi-directional connection 111. The bi-directional connection 111 can comprise one or more direct connections, wireless connections, and/or networks. In an embodiment, the connections 109 and 111 may form at least part of a local area network (LAN) to which the DNS server 108 and the query engine 112 are connected.

The query engine 112 comprises a search parser 115 and a table 125. In an embodiment, the search parser 115 receives a natural language query from the user device 102, via the DNS 108, and the location or position of the user device 102 from the DNS 108 and together with the query engine 112 attempts to apply context aware parameters (such as the location of the user device 102) to the natural language query to determine a domain or an IP address that is likely to correspond to the subject matter of the natural language query. In an embodiment, the table 125 contains a listing of topics generated from parsed search queries and the domain or IP address information of a web server that is likely to have the information related to the natural language search query. The table 125 may contain any metadata and/or description of a data association. For example the word “flight” in the context of an airport would mean a gate & flight number, but in the context of an amusement park, the word “flight” would refer to an amusement attraction. Although shown as residing outside of the DNS 108, the query engine 112 may be incorporated into the DNS 108, or may be part of another element connected to the network 106 and accessible by the DNS 108.

Once the query engine 112 determines one or more possible or likely IP addresses or domains that may at least partially match or correspond to the subject of the natural language query and sends this information to the DNS 108, the DNS 108 sends the IP address of the user device and the query subject to an appropriate web server. An appropriate web server is one that likely contains information related to the natural language query and that is identified by the DNS 108. In an example, the appropriate web server is the web server 110. The DNS 108 also sends a domain name (and/or IP address) of the appropriate web server, such as the web server 110, to the user device 102 so that the user device 102 is aware that the web server 110 is a likely source for an answer corresponding to the natural language query.

The DNS 108 is connected to the web server 110 over a bi-directional connection 119, and is connected to the web server 120 over a bi-directional connection 117. The bi-directional connections 117 and 119 can comprise one or more direct connections, wireless connections, and/or networks.

In an embodiment in which the web server 110 is the likely source for an answer corresponding to the natural language query, the web server 110 may access the query cache 113 in the DNS 108 so when the web server 110 receives the actual request from the DNS 108, the web server 110 can access the query cache 113 to determine the original natural language query sent by the user device 102. An example of the information contained in the query cache 113 may be [IP, UA123, www.domain1.com], where the term “IP” refers to the IP address of the user device 102, the term “UA123” is the natural language query, and the term “www.domain1.com” refers to the URL of the web server 110.

Once the user device 102 obtains from the DNS 108 a domain name, an IP address, or other identifier, of an appropriate web server, such as the web server 110, the user device then sends an HTTP request to the web server 110. The HTTP request may include contextual information related to the user device 102. In this manner, the DNS 108 points the web browser 104 on the user device 102 to the most appropriate source for an answer to the original natural language query.

The web server 110 matches the IP address of the user device 102 received from the DNS 108 with the IP address of the user device in the recently received HTTP request, as shown by table 130. The web server 110 then sends appropriate content (a response to the natural language query) to the user device 102 based on the context provided by the DNS 108.

FIG. 2 is a call flow diagram 200 illustrating an embodiment of a method to allow a domain name server (DNS) to process a natural language query and determine context. The diagram 200 illustrates the operation of various elements in FIG. 1 for reference. As an example, call 202 represents a natural language search query entered into a web browser 104 in a user device 102. The call 202 is sent via the network 106 to the DNS 108. In this example, the user device 102 can be located in an airport and the natural language query can be a flight number, such as “UA123.” In this example, the natural language query “UA123” does not include any information related to a domain name and therefore, the DNS 108 cannot map “UA123” directly to a domain name or to an IP address.

The DNS 108 receives the natural language query and attempts to return a domain name or an IP address relating to the natural language query “UA123.” However, the DNS 108 cannot locate a domain or an IP address that corresponds to “UA123.” The DNS 108 engages the location/position element 116. The call 204 represents the DNS 108 contacting the location/position element 116 to determine the location of the user device 102.

The call 206 represents the location/position element 116 returning the location of the user devoice 102 to the DNS 108.

The call 208 sent from the DNS 108 to the query engine 112 represents the DNS 108 attempting to determine a domain or an IP address for the natural language query “UA123.” The call 208 includes the location information provided by the location/position element 116.

The DNS 108 employs the location/position element 116 and the query engine 112 to determine the context (in this example, the location) of the user device 102, and an appropriate web server that may have information that satisfies the natural language query “UA123” based on the context information obtained from the location/position element 116 and the natural language query. This is accomplished without employing an external search engine, such as a search engine or a search function provided by Google or Yahoo, for example.

The call 210 represents the query engine 112 returning to the DNS 108 with an IP address, or other identifier, of a web server that likely includes the information relating to the natural language query. In this example, the query engine 112 determines that the web server 110 (FIG. 1) is the likely source of the information sought by the natural language query “UA123.”

After determining the context, such as the physical location of the user device 102 from the location/position element 116, and a likely web server to respond to the query from the query engine 112, the DNS 108 sends a call 212 to the appropriate web server 110. The call 212 includes the IP address of the user device 102 and includes the subject of the query (“UA123”) that is embodied in the call 202. This is illustrated in the table 130 in FIG. 1 as the “Query and IP Address of User Device” being placed in the table 130 accessible by the web server 110.

The DNS 108 also sends a call 214 having the domain name and/or IP address of the web server 110 to the user device 102. In this example, the domain is “www.domain1.com.”

Having the domain name and/or IP address of the web server 110, the user device 102 issues a call 216 to the web server 110. The call 216 includes an HTTP request directed to the IP address of the web server 110. The call includes the IP address of User Device, as illustrated in the table 130 in FIG. 1. The web server 110 matches the IP address and query (“UA123”) of the user device 102 received from the DNS 108 with the IP address of the user device just received in the HTTP request in call 216. In response, the web server 110 responds to the user device 102 with a call 218 representing the appropriate content (query response) based on the context provided by the DNS 108.

In an embodiment in which the web server 110 is the likely source for an answer corresponding to the natural language query, the web server 110 may access the query cache 113 in the DNS 108 so when the web server 110 receives the actual request from the DNS 108 (call 212), the web server 110 can access the query cache 113 to determine the original natural language query sent by the user device 102. In this example, the original natural language query was “UA123.” The contents of the query cache 113 would be [IP, UA123, www.domain1.com], where the term “IP” refers to the IP address of the user device 102, the term “UA123” is the natural language query, and the term www.domain1.com refers to the URL of the web server 110.

FIGS. 3A and 3B collectively are a flow chart 300 illustrating an embodiment of a method to allow a domain name server (DNS) to process a natural language query and determine context. In block 302, a DNS server 108 receives a natural language query from a user device 102. An example of a natural language query is a flight information request in the form of typing “UA123” into the browser 104. The natural language query “UA123” is intended to be a simplified example using flight information being sought at an airport. Any natural language query can be processed as described herein.

In block 304, the DNS 108 determines if the query received in block 302 resolves to a domain name or to an IP address. If the query resolves to a domain name or to an IP address, then in block 306 the DNS 108 issues a domain name and/or an IP address corresponding to the request to the web browser 104 and the process ends.

If the query does not resolve to a domain name or to an IP address, then, in block 308 the DNS 108 determines the context of the user device and attempts to process the query and determine an appropriate web server that is likely to have information corresponding to the query. In an embodiment, the DNS 108 receives the natural language query and employs the location/position element 116 and the query engine 112 to determine the context (in this example, the location) of the user device 102, and to determine an appropriate web server that may have information that satisfies the natural language query. For example, the DNS 108 can call the location/position element 116 in an attempt to determine the location of the user device 102. In this example, the location/position element 116 returns the location of the user device 102 to the DNS 108. The DNS 108 then forwards the natural language query and the location of the user device 102 to the query engine 112. This is accomplished without employing an external search engine, such as a search engine or a search function provided by Google or Yahoo, for example.

In block 310, the search parser 115 in the query engine 112 parses the natural language query, the query engine 112 applies the location information provided by the DNS 108, and compares the parsed natural language query to a table 125 of web servers that may or that may likely correspond to the parsed natural language query. For example, the search parser 115 will map the input (user input) into a topic. In this example, the query UA123 will be mapped to the topic called “FLIGHT NUMBER”. The table 125 contains an entry corresponding to (FLIGHT NUMBER, Location: Airport, web site location of appropriate source of information (e.g., www.gatefinder.com for airport gate information). The table 125 may contain other entries as well that may be related to the natural language query, such as, for example, another entry like (FLIGHT NUMBER, location: Mall, web site location of mall map) and another entry like (FLIGHT NUMBER, Location: All but airport and malls, web site location of flight tracker). The query engine 112 sends to the DNS 108 the IP address, or another identifier, of one or more selected web servers that likely contain the information related to the natural language query.

In block 312, the DNS 108 uses the response from the query engine 112 and sends the IP address of the user device 102 and the query subject (“UA123”) to the selected web server 110.

In block 314, the DNS 108 sends the IP address, or other identifier, of the selected web server 110 to the user device 102.

In block 316, the user device 102 sends an HTTP request to the selected web server 110. The HTTP request may include information related to the context (such as the location) of the user device 102.

In block 318, the selected web server 110 matches the IP address and query subject (“UA123”) of the user device 102 received from the DNS 108 with the IP address of the user device 102 just received in the HTTP request. The web server 110 may access the query cache 113 in the DNS 108 (FIG. 1) so that when the web server 110 receives the actual processed request from the DNS 108, the web server 110 can access the query cache 113 to determine the original natural language query sent by the user device 102.

In block 322, the selected web server 110 responds to the user device 102 with the appropriate content (query response to (“UA123”)) based on the context provided by the DNS 108.

FIG. 4 is a block diagram of the query engine of FIG. 1.

A natural language query is provided to the search parser 115 from the DNS 108 (FIG. 1). The search parser 115 comprises a processor 402 and a memory 404 operatively coupled together over a bus 406. The processor 402 can be a general purpose or special purpose microprocessor, or any other processor capable of executing instructions. The memory 404 can be any type of volatile or non-volatile memory, and in an embodiment, can include flash memory. The bus 406 can comprise physical and logical connections that allow the memory 404 and the processor 402 to communicate and interoperate, and that allow the processor 402 to execute the instructions provided by parse logic 410 and comparison logic 415.

In this example, the parse logic 410 and the comparison logic 415 are located in the memory 404 and are accessible to the processor 402 for execution. In an embodiment, a natural language query from the DNS 108 is operated on by the parse logic 410 so as to analyze and deconstruct the query into its constituent components, resulting in a parse tree 408 showing their syntactic relation to each other, which may also contain semantic and other information. In this example, the natural language query is “UA123” and the parse logic 410 deconstructs the query to its constituent terms “U”, “A”, and “123.” The parse logic 410 realizes that the search term “UA123” together with the contextual location information that informs the query engine 112 that the user is located at an airport, results in a parse tree 408 having the terms “United,” “Air,” “Lines,” and “123.” The relationship among these constituent terms is illustrated by the arrows connecting the terms. Having the location information and the parsed search terms “United,” “Air,” “Lines,” and “123” causes the query engine 112 to reach a conclusion that the natural language query “UA123” relates to information related to United Airlines, flight 123. For example, the search parser 115 will map the input “UA123” to a topic, where in this example, the topic is “FLIGHT NUMBER.”

FIG. 5 is a block diagram of the table 125 of FIG. 4. The search parser 115 maps the input “UA123” into the topic “FLIGHT NUMBER”. The table 125 contains an entry corresponding to (FLIGHT NUMBER, Location: Airport, web site location of appropriate source of information (e.g., www.gatefinder.com for airport gate information), indicating that the web server 110 having the domain www.gatefinder.com is the likely source for the answer to the query “UA123.”

The parse tree 408 is used to develop the table 125, which associates the topic of the parsed query to one or more of the web servers 110 and 120 to determine which web server may be a likely source of the information sought in the query. In this example, the query engine 112 may also comprise comparison logic 415 configured to compare the parsed natural language query to the list of web servers that are likely to include information related to the parsed natural language. In this example, the query engine 112 may conclude that the web server 110 has gate information related to United Airlines flight number 123 and is selected to be the likely source of the information sought in the query.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method for processing a natural language query and determining context, comprising:
receiving a natural language query from a user device;
determining context of the user device;
using the determined context to identify a web server having information related to the natural language query;
sending information identifying the user device and the natural language query to the web server; and
identifying the web server to the user device.

2. The method of claim 1, further comprising:
the user device sending an HTTP request to the web server, the HTTP request including information identifying the user device; and
the web server sending contextual content to the user device, the contextual content related to the natural language query.

3. The method of claim 2, wherein the context of the user device comprises a location of the user device.

4. The method of claim 2, wherein identifying a web server having information related to the natural language query further comprises:
parsing the natural language query;
comparing the parsed natural language query to a list of web servers that likely include information related to the parsed natural language query; and
selecting one of the web servers based on the comparison.

5. The method of claim 4, further comprising:
determining a topic related to the parsed natural language query; and
selecting one of the web servers based on the determined topic.

6. A system for processing a natural language query and determining context, comprising:
a user device configured to send a natural language query;
a domain name server having logic for obtaining context of the user device;
logic for using the determined context to identify a web server having information related to the natural language query;
the domain name server sending information identifying the user device and the natural language query to the web server; and
the domain name server identifying the web server to the user device.

7. The system of claim 6, further comprising:
the user device sending an HTTP request to the web server, the HTTP request including information identifying the user device; and
the web server sending contextual content to the user device, the contextual content related to the natural language query.

8. The system of claim 7, wherein the context of the user device comprises a location of the user device.

9. The system of claim 7, wherein the logic for using the determined context to identify a web server having information related to the natural language query further comprises:
a search parser configured to parse the natural language query;
comparison logic configured to compare the parsed natural language query to a table of web servers that likely include information related to the parsed natural language; and
selection logic configured to select one of the web servers based on the comparison.

10. The system of claim 9, further comprising:
logic for determining a topic related to the parsed natural language query; and
logic for selecting one of the web servers based on the determined topic.

11. The system of claim 6, wherein the domain name server further comprises a query cache for storing information related to the user device, the natural language query and the web server.

12. The system of claim 11, wherein the web server accesses the query cache to determine the natural language query and the user device.

13. A system for processing a natural language query and determining context, comprising:
a user device configured to send a natural language query;
a domain name server having logic for obtaining a location of the user device;
logic for using the determined location to identify a web server having information related to the natural language query;
the domain name server sending information identifying the user device and the natural language query to the web server; and
the domain name server identifying the web server to the user device.

14. The system of claim 13, further comprising:
the user device sending an HTTP request to the web server, the HTTP request including information identifying the user device; and
the web server sending contextual content to the user device, the contextual content related to the natural language query.

15. The system of claim 14, wherein the logic for using the determined location to identify a web server having information related to the natural language query further comprises:
a search parser configured to parse the natural language query;
comparison logic configured to compare the parsed natural language query to a table of web servers that likely include information related to the parsed natural language; and
selection logic configured to select one of the web servers based on the comparison.

16. The system of claim 14, wherein the domain name server further comprises a query cache for storing information related to the user device, the natural language query and the web server.

17. The system of claim 16, wherein the web server accesses the query cache to determine the natural language query and the user device.
